(19) United States
(12) Patent Application Publication
(10) Pub. No.: US 2013/0124916 A1
(43) Pub. Date: May 16, 2013

(54) LAYOUT OF MIRRORED DATABASES ACROSS DIFFERENT SERVERS FOR FAILOVER

(71) Applicants: David R. Shutt, Seattle, WA (US); Syed Mohammad Amir Ali Jafri, Seattle, WA (US); Chris Shoring, Sammamish, WA (US); Daniel Lorenc, Bellevue, WA (US); William P. Munns, Bellevue, WA (US); Matios Bedrosian, Bothell, WA (US); Chandra Akkiraju, Bothell, WA (US); Hao Sun, Sammamish, WA (US)

(72) Inventors: David R. Shutt, Seattle, WA (US); Syed Mohammad Amir Ali Jafri, Seattle, WA (US); Chris Shoring, Sammamish, WA (US); Daniel Lorenc, Bellevue, WA (US); William P. Munns, Bellevue, WA (US); Matios Bedrosian, Bothell, WA (US); Chandra Akkiraju, Bothell, WA (US); Hao Sun, Sammamish, WA (US)

(73) Assignee: Microsoft Corporation, Redmond, WA (US)

(21) Appl. No.: 13/298,263

(22) Filed: Nov. 16, 2011

(51) Int. Cl. G06F 11/20

(52) U.S. Cl. 714/6.3; 714/E11.089

(57) ABSTRACT

A plurality of data centers each having a plurality of servers. When there is a failure on a data center, the load for the failed portion of the data center is distributed over all the remaining servers locally, or remotely, based on the magnitude of the failure.

### BACKGROUND

Database systems are currently in wide use. In general, a database system includes a server that interacts with a data storage component to store data (and provide access to it) in a controlled and ordered way.

Database servers often attempt to meet two goals. The first is to have high availability so that a variety of different users can quickly and easily access the data in the data store. The second goal is to have a system that enables data recovery in the event of a catastrophic failure to a portion of the database system.

Some systems have attempted to meet these goals by providing a database minor on either a local or a remote server. That is, the data on a given database is mirrored, precisely, on a second database that is either stored locally with respect to the first database, or remotely from the first database. If the first database fails, operation simply shifts to the mirror while the first database is repaired.

Of course, this type of solution is highly redundant. For a given amount of data to be stored, this type of system essentially requires double the amount of memory and processing. Therefore, it is an inefficient system.

The discussion above is merely provided for general background information and is not intended to be used as an aid in determining the scope of the claimed subject matter.

### SUMMARY

A plurality of data centers each have a plurality of servers. When there is a failure on a data center, the load for the failed portion of the data center is distributed over all the remaining servers locally, or remotely, based on the magnitude of the failure.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative embodiment of a set of data centers.

FIG. 2 is a flow diagram illustrating one embodiment of the operation of the system shown in FIG. 1 during failover of one of the data storage components.

FIGS. 3A-3I show the layout of database accessibility groups across servers in multiple different data centers, in accordance with one embodiment.

FIG. 4 is a block diagram of one illustrative computing environment.

### DETAILED DESCRIPTION

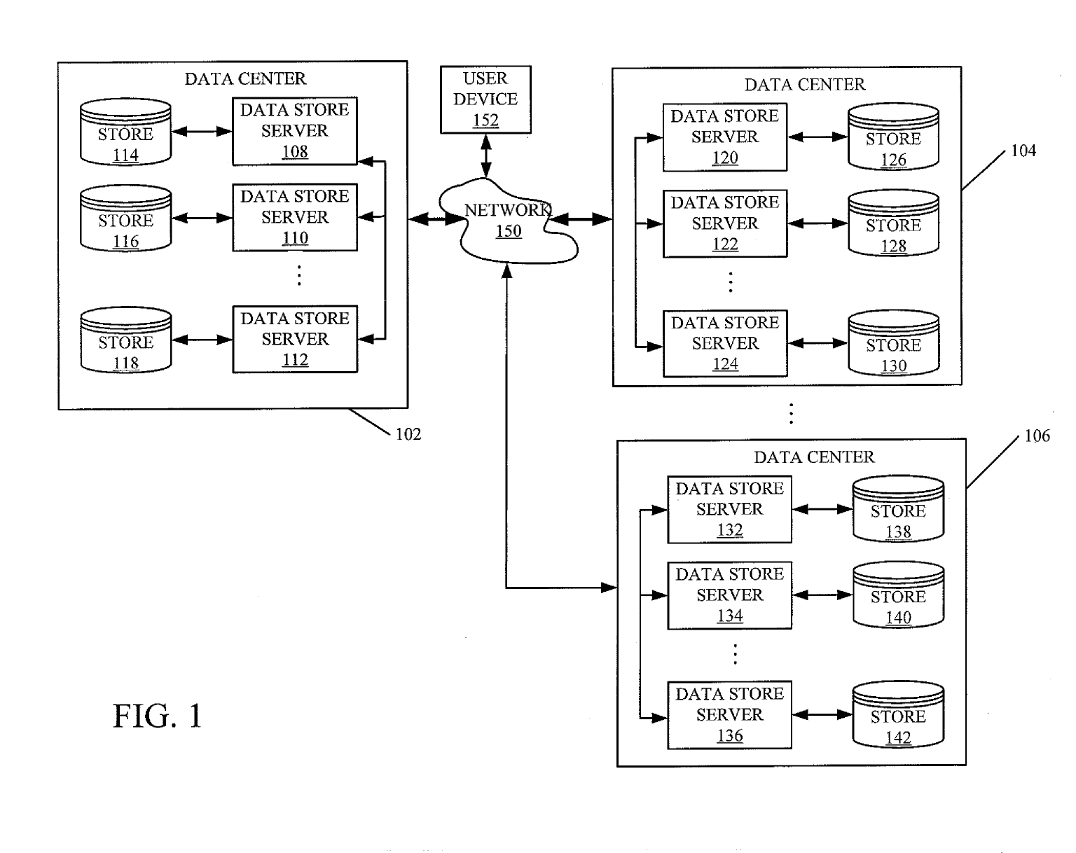

FIG. 1 is a block diagram of various components of one illustrative data storage system 100. Data storage system 100 illustratively includes a plurality of data centers 102, 104 and 106. Of course, it will be noted that two or more data centers can be used and the three illustrated in FIG. 1 are shown for the sake of example only. FIG. 1 also shows that each data center illustratively includes a set of data store servers and data stores. For instance, data center 102 includes data store servers 108, 110 and 112 each of which have a corresponding data store 114, 116 and 118, respectively. It will also be noted, of course, that additional data store servers and data stores can be used in a given data center, but the three shown in data center 102 are shown for the sake of example only.

FIG. 1 also shows that data center 104 has data store servers 120, 122 and 124, each of which has an associated data store 126, 128 and 130, respectively. In addition, FIG. 1 shows that data center 106 has data store servers 132, 134 and 136, each of which has an associated data store 138, 140 and 142. Again, the number of data store servers and data stores can be different from that shown in FIG. 1, and the embodiment shown in FIG. 1 is shown for illustrative purposes only.

FIG. 1 also shows that each of the data centers 102, 104 and 106 communicate with one another, illustratively, over a network 150. Network 150 can be a local or wide area network. In one embodiment, each data store server comprises a database server that uses a computer processor to perform database server functionality for storing data on, and retrieving data from, its corresponding data store, in an ordered way. A user can use device 152 which can be connected directly to one of the data stores, or through network 150 as well. In this way, the user can access data in the data centers. Thus, a user accessing one of data stores 102-106 through user device 152 can gain access to data stored on one of the data stores on one of the data centers through its corresponding database server.

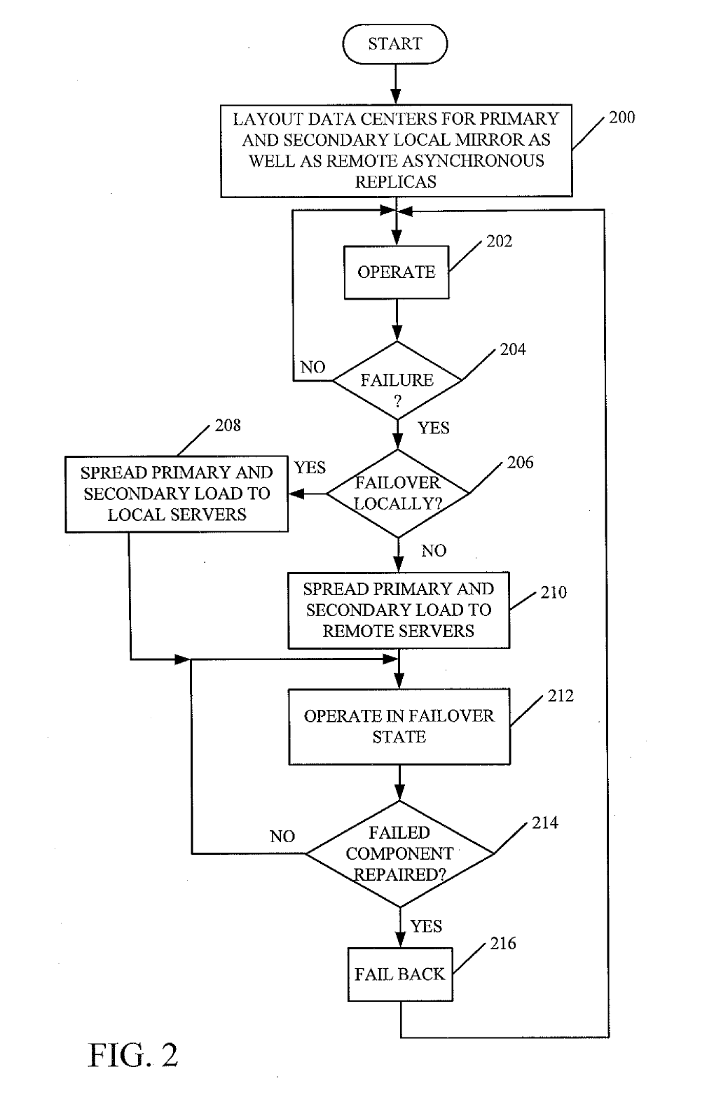

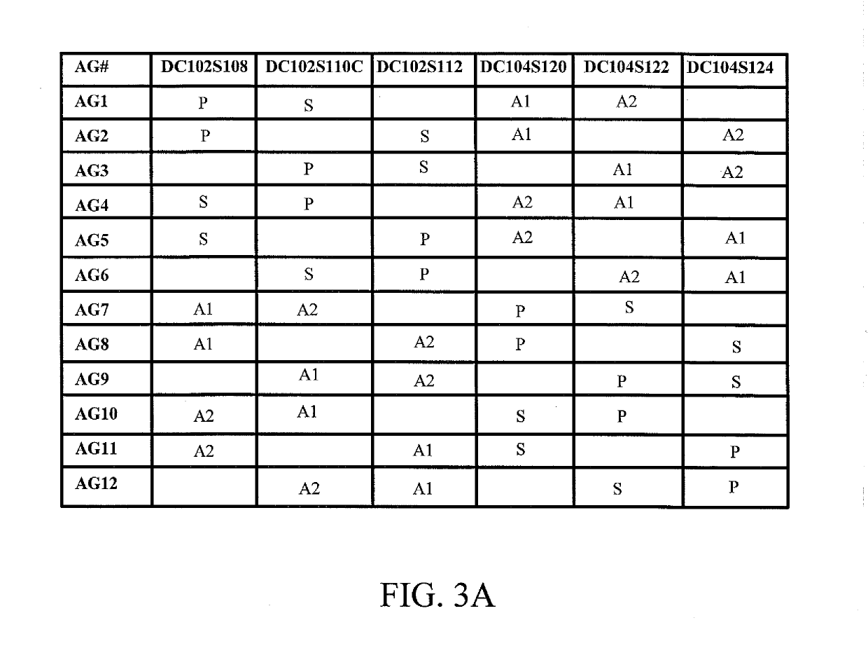

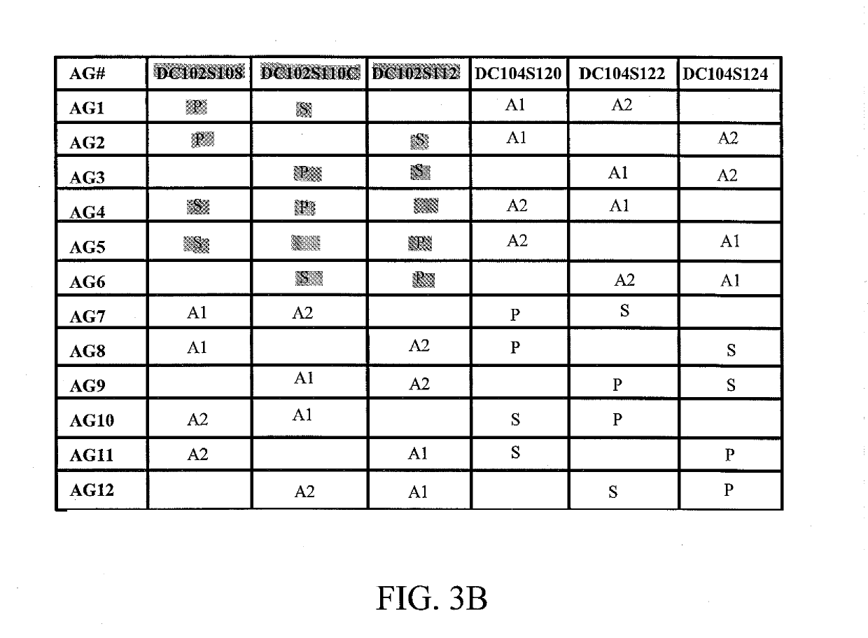

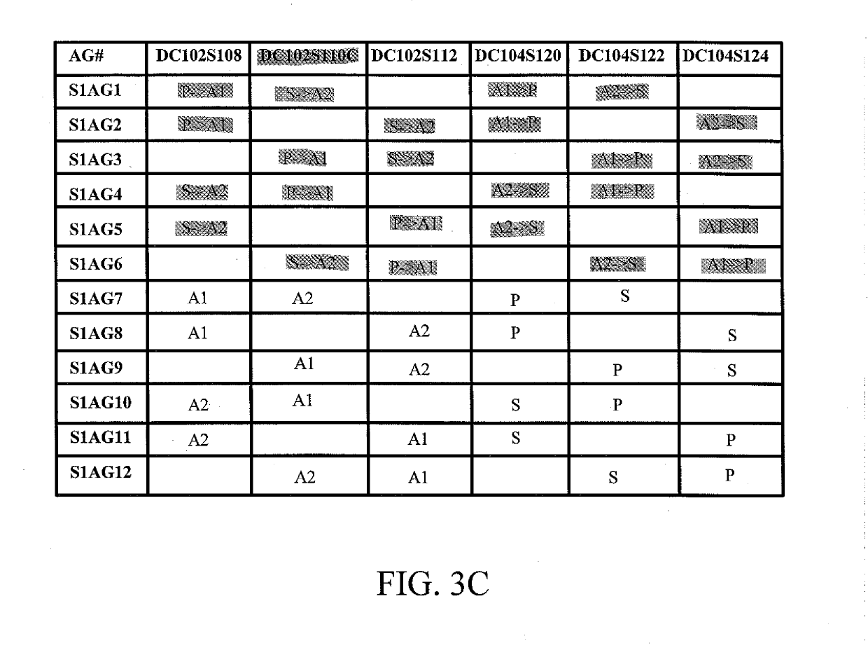

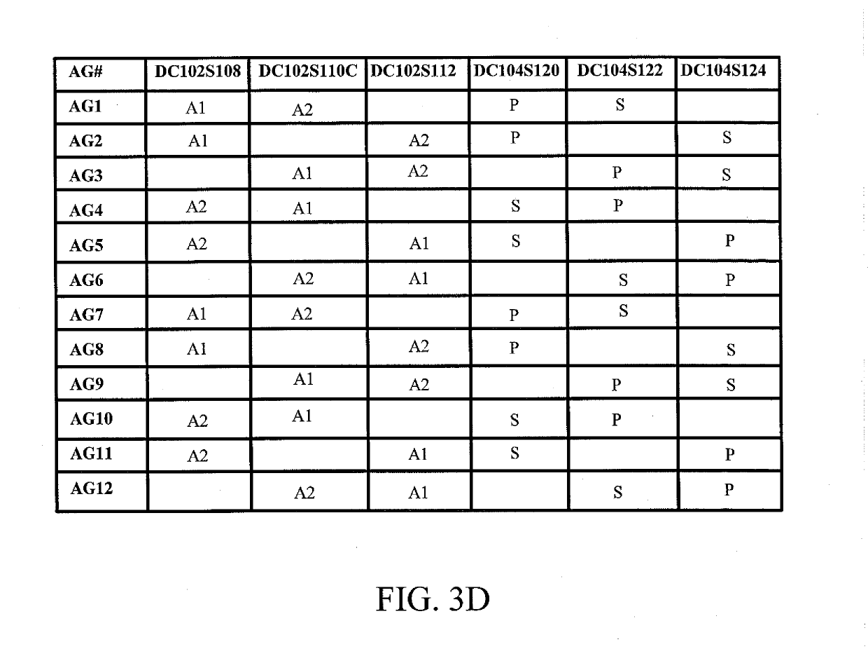

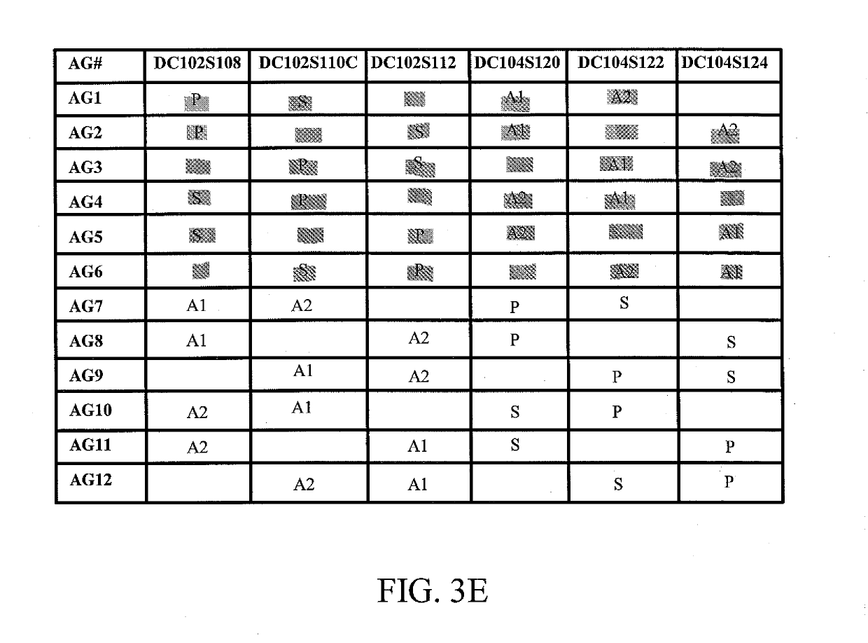

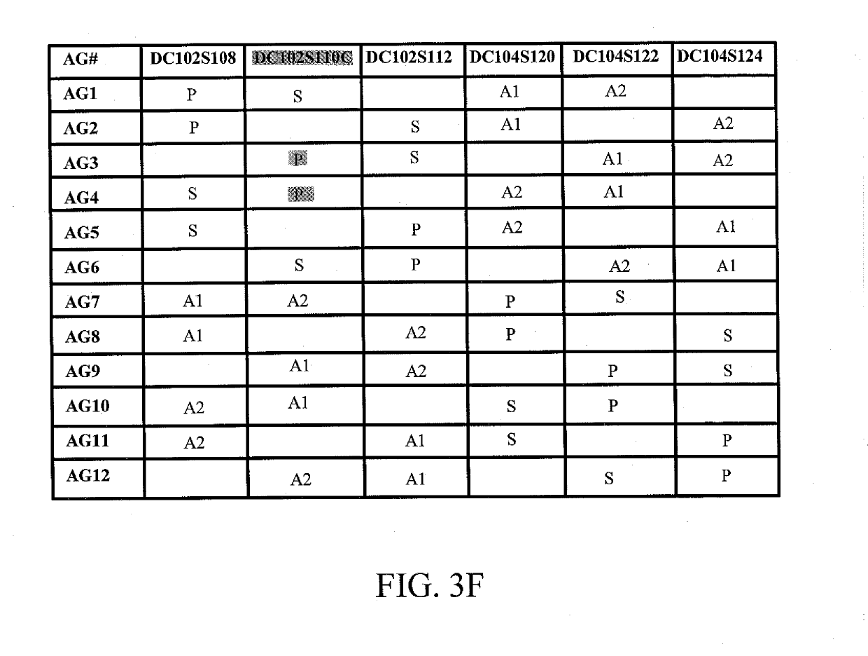

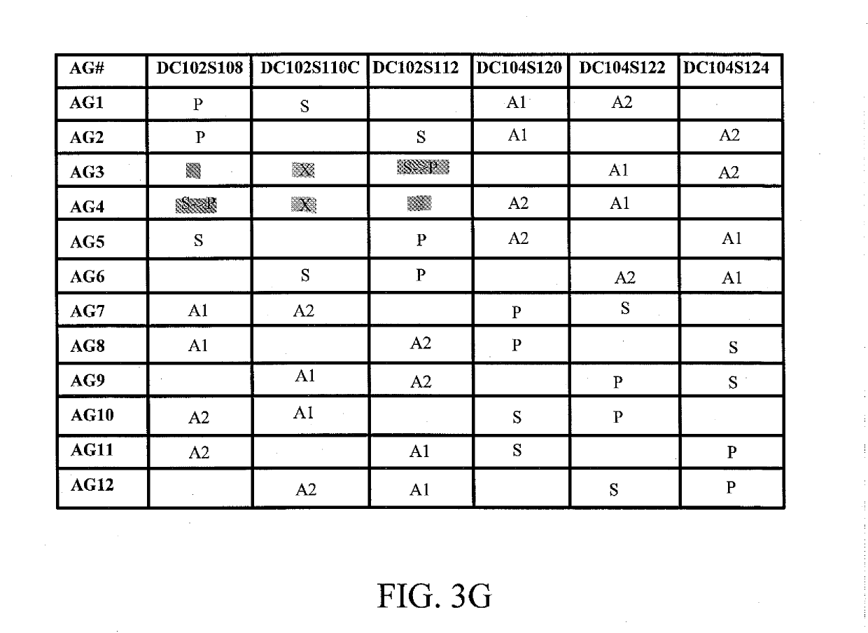

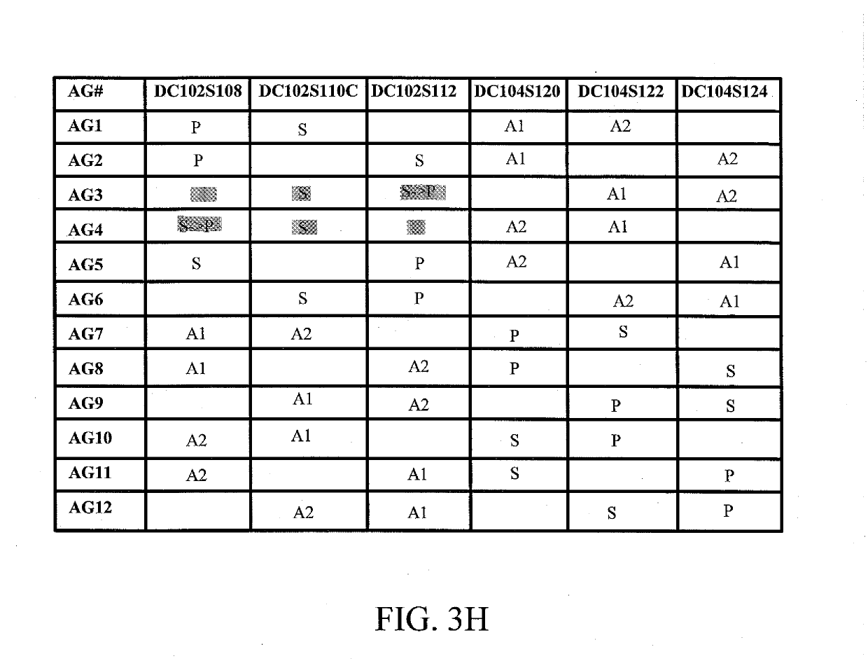

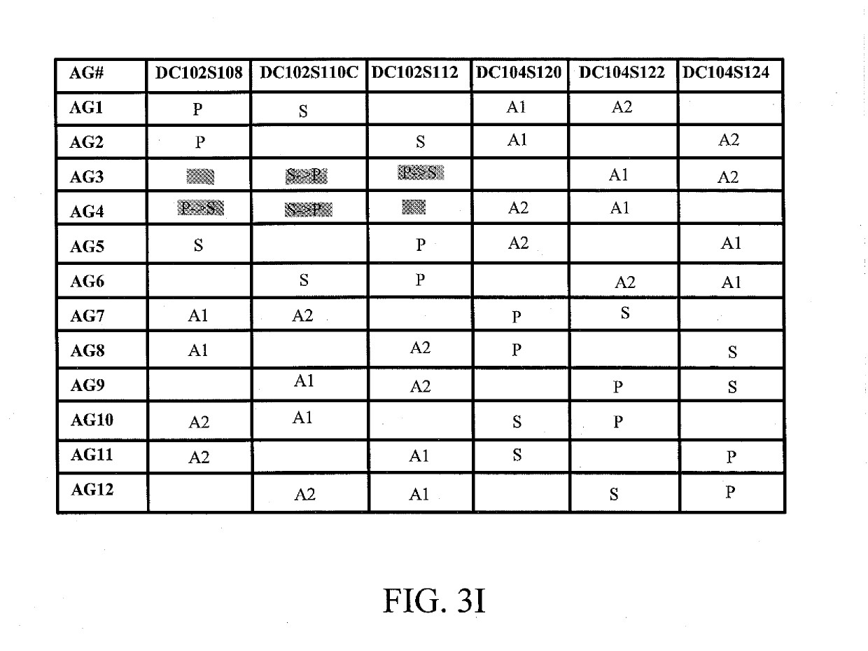

FIG. 2 is a flow diagram illustrating one embodiment of the operation of system 100 shown in FIG. 1, in the event of failure of one or more data store servers or data centers. FIGS. 3A-3I show the layout of each of the databases across an embodiment in which there are three data store servers per data center, and in which there are only two data centers. Therefore, while FIG. 1 shows an embodiment can include more than two data centers, where each data center has three or more data store servers, the embodiment described with respect to FIGS. 2 and 3A-3I is one in which there are only three data store servers per data center, and in which there are only two data centers. Of course, the features discussed with respect to FIGS. 2-3I will apply equally as well to embodiments which have more than two data centers, and/or embodiments in which each data center has more than three data store servers. The description of FIGS. 2-3I is provided for the sake of example only.

Also, the discussion of FIGS. 2-3I will refer to availability groups. An availability group refers to a set of data bases that share common worker threads and in-memory storage. This set of databases shares functionality. Availability groups are used to define how to configure the databases so that they fail over together. Therefore, an availability group is the smallest unit of measure used to distribute database service load among a plurality of database servers.

FIG. 2 describes one embodiment of the overall operation of system 100 shown in FIG. 1 (again where there are only two data centers each having three data store servers thereon) during fail over operation, which occurs when one of the database servers or a data center fails. At the outset, the databases are laid out in the data centers so that there are primary and secondary local mirrors of the databases as well as remote, asynchronous replicas of the various databases. This is indicated by block 200 in FIG. 2.

In order to describe this in more detail, FIG. 3A is a chart showing one illustrative layout of the databases in an embodiment in which two data centers (data center 102 and data center 104 in FIG. 1) are used, and in which each data center has three data store servers (servers 108, 110 and 112 on data center 102, and servers 120, 122 and 124 on data center 104). Therefore, FIG. 3A shows the layout of databases across all six servers in the two data centers 102 and 104.

The horizontal axis of FIG. 3A has terms “DCxSy”. The “DC” refers to data center and the “S” refers to server. Therefore “DC102S108” refers to server 108 in data center 102. Similarly, the term “DC104S120” refers to data store server 120 in data center 104.

The vertical axis in FIG. 3A refers to the availability group number. In the embodiment discussed herein, there are 12 availability groups. These are labeled AG1-AG12. Each availability group illustratively includes more than one database, but the databases in each availability group are managed together for the purposes of disaster recovery.

Therefore, as shown in FIG. 3A, there are a number of cells that define a matrix. Each cell in the matrix indicates what is stored at a given data center on a given server. The letter “P” in a cell indicates that the primary copy of that availability group is stored at that location. For instance, in the first row of FIG. 3A, it can be seen that the primary copy of availability group 1 is stored at data center 102 and data store server 108 in FIG. 1. It can also be seen from the first row in FIG. 3A that asynchronous copies of availability group 1 are maintained at data center 104 and data store servers 120 and 122, respectively. Thus, FIG. 3A shows one embodiment of an initial layout of the availability groups across both data centers 102 and 104 and all six data store servers 108, 110, 112, 120, 122 and 124. FIG. 3A shows where each primary and secondary copy of each availability group is maintained, as well as where first and second asynchronous replicas of that availability group are maintained as well. Laying out the primary and secondary local mirrors of each availability group as well as remote asynchronous replicas is indicated by block 200 in FIG. 2.

Once the databases are laid out as shown in FIG. 3A, the data store servers simply perform regular database operations. This includes storing and fetching data, for example, and is indicated by block 202 in FIG. 2.

At some point, one or more of the data store servers, data stores, or data centers fails. This is indicated by block 404 in FIG. 2. If a failure occurs, one or more of the processors used to implement each of the data store servers determine the magnitude of the failure, such as the number of data store servers that have failed, and whether the data can fail over locally or whether it more desirably fails over remotely. This is indicated by block 206 in FIG. 2.

For instance, assume that data store server 108 in data center 102 fails. In this case, each of the remaining data store servers 110 and 112 will take over the operations of data store server 108 and the load from data store 108 will be balanced equally across both local servers 110 and 112. This is indicated by block 208 in FIG. 2. If more than one data store server fails on a given data center (for instance) then all of the primary and secondary replicas of the availability groups on that given data center will be transferred to another data center and spread evenly across the data store servers that are operational on that data center. This is indicated by block 210 in FIG. 2. Of course, the magnitude of failure (e.g., number of servers or data stores that fail) that can be accommodated locally, or that are to be handled remotely, can vary based on application, the number of servers per data center, or otherwise, as desired. For the present example, failure of one server can be handled locally at the data center, while failure of two or more servers on a given data center will result in fail over to a remote data center. These numbers are used for exemplary purposes only.

By way of example, assume that both data store servers 108 and 110 on data center 102 fail. In that case, all the primary and secondary replicas of the availability groups on data center 102 will be migrated to data center 104, and the load associated with those availability groups will be spread equally across the servers on data center 104. The processors that run data store servers 108, 110 and 112 in data center 102 determine whether enough of the components on data center 102 have failed to warrant remote failover or whether local failover is adequate.

These operations can be better be understood with reference to FIGS. 3B-3I. FIG. 3B has the same matrix as shown in FIG. 3A, except that a number of the cells in FIG. 3B are highlighted. This indicates that enough servers on data center 102 have failed that the fail over is to be done remotely to data center 104. The highlighted cells are those cells which will need to be failed over from data center 102 to data center 104. Thus, it can be seen that all three servers (S108, S110 and S112) on data center 102 are affected, and all of the availability groups (AG1-AG6) that have either a primary or a secondary replica on any of the servers in data center 102 will be affected as well.

FIG. 3C shows what happens during the fail over operation. Basically, the fail over operation causes all of the availability groups with primary and secondary replicas on the servers on data center 102 to fail over, and be equally distributed, among the servers on data center 104. For instance, assuming that two or more of servers 108-112 on data center 102 fail, the load of all of the availability groups on data center 102 will be transferred to, and distributed among, the servers on data center 104.

FIG. 3C shows all of the affected servers and availability groups as being shaded or highlighted. It can be seen from the first row of FIG. 3C that the primary copy of availability group 1 (which previously resided on server 108 in data center 102) will be transferred to data center 104 and server 120. The secondary replica of availability group 1 will be transferred from data center 102, server 100, to data center 104, server 122. The places where the primary and secondary replicas of availability group 1 previously resided (on data center 102) will, once repaired, be used to serve and maintain the first and second asynchronous replicas of availability group 1. The same is true for all of the other availability groups A2-A6 which previously had their primary and secondary replicas on data center 102. The primary and secondary replicas will now be transmitted to the data store servers 120-124 on data center 104, and split equally among them. Therefore, data center 102 will now only be responsible for maintaining asynchronous replicas on it so that it can be safely repaired or patched. Meanwhile, the services for all the primary and secondary replicas of availability groups 1-6 will be served from the appropriate servers in data center 104. Servicing all of the availability groups in this way is referred to as operation in the fail over state. System 100 operates in the fail over state (where operations are being served from data center 104) while the various components of data center 102 are being repaired. This is indicated by blocks 212 and 214 in FIG. 2. FIG. 3D shows the layout of the databases when all of the availability groups are being served from data center 104, in the remote fail over state.

Once data center 102 is repaired, it will issue a fail back command. That is, one of the processors that implements servers 108-112 will determine that the components of data center 102 have been sufficiently repaired that data center 102 can again start servicing the primary and secondary replicas of availability groups 1-6. The processor will transmit this message, via network 150, to data center 104. The processors corresponding to servers 120-124 (which are now performing the primary and secondary service for availability groups 1-6) will then transmit the load for those availability groups back to data center 102, where they originally resided. Basically, the fail back command causes the availability groups 1-6 to go back to their default state and it reinstates the replica relationships which were originally used. This can be seen in FIG. 3E, which shows all of the cells that are affected by the fail back command. Failing back to the original state is indicated by block 216 in FIG. 2.

FIGS. 3F-3I are similar to FIGS. 3A-3E above, except that they show the layout of the databases for a local fail over. Assume, for instance, that data store server 110 in data center 102 fails, but that no other servers 108 or 112 in data center 102 failed. In that case, a local fail over is performed where the load carried by data store server 110 is spread equally between servers 108 and 110 on data center 102, without involving any other data center. FIG. 3F shows a matrix similar to that shown in FIGS. 3A-3I, except that it has highlighted the cells for availability groups 3 and 4, which will be affected in the event of a failure of data store server 110.

FIG. 3G shows the layout of the databases after the local fail over has occurred. It can be seen from FIG. 3G that the primary location of availability group 3 shifts to what was originally its secondary replica on data center 102, server 112. Similarly, the primary location of availability group 4 shifts to what was its secondary location, on data center 102, server 108. It can thus be seen that the primary location for one availability group has shifted to server 112 and the primary location for another availability group has shifted to server 108. Thus, the primary load from server 110 is split equally among servers 108 and 112. Therefore, after the local fail over operation has been performed, the failed server 110 holds only secondary replicas of availability groups. This allows it to be taken off line and repaired, if needed, and the primary servers for all availability groups, on data center 102 will be provided by servers 108 and 112.

Once server 110 has been repaired, and comes back on line, its state is shown in FIG. 3H. It still has only secondary locations for availability groups, but it is ready for the availability groups to be restored to their default state so that it can resume performing primary services for availability groups 3 and 4. Therefore, it issues a fail back command. FIG. 3I illustrates this. It can be seen in FIG. 3I that the primary location for availability group 3 is shifted back from server 112 to server 110, and server 112 now only maintains the secondary location of availability group 3. Similarly, the primary location for availability group 4 is shifted from server 108 to server 110, and server 108 again only maintains the secondary location of availability group 4. Thus, data center 102 is returned to its default layout shown in FIG. 3A.

It can thus be seen that if each data center has N servers, then each server originally bears 1/N of the load for the local availability groups. If one of those servers fails, the load is redistributed among the remaining active servers so that each server only bears one 1/(N−1) of the overall load. Thus, where a data center has three servers, and the primary location of six availability groups are distributed among those three servers, then each server initially bears the load of providing the primary location for ⅓ of the six availability groups (or two of the availability groups). If one of the servers fails, then each of the remaining servers provides a primary location for 1/(3−1)=½ of the six availability groups (or each of the two remaining servers provides primary locations for three of the availability groups). Thus, if there are three servers and six availability groups per data center, each of the servers can run at 66.6 percent of its capacity, while still providing a high level of data availability and disaster recovery. As the number of servers per data center goes up, each server can run at an even higher percentage of its capacity.

Similarly, where there are M data centers, then each server in each data center bears the load of 1/(N×M) of the primary locations of the availability groups. If one of the data centers fails, then each of the remaining servers bears a load of 1/(N×M−1) of the load. Thus, as the number of servers or data centers increases, then each of the individual servers can run at a relatively high level of capacity, while still maintaining adequate redundancy to provide disaster recovery, and while still providing high data availability rates.

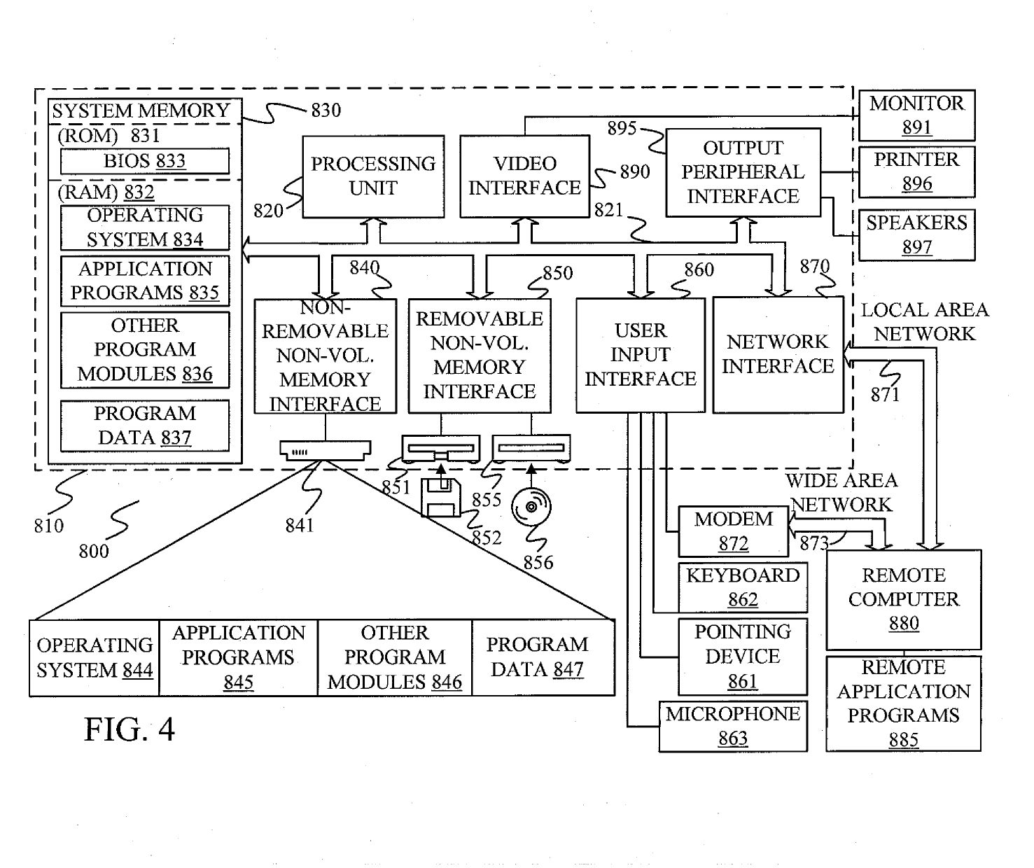

FIG. 4 is one embodiment of a computing environment which can be used in deploying the data storage system shown in FIG. 1. With reference to FIG. 4, an exemplary system for implementing some embodiments of the user device 152 or servers and stores includes a general-purpose computing device in the form of a computer 810. Components of computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 4.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 4 illustrates operating system 834, application programs 835, other program modules 836, and program data 837.

The computer 810 may also include other removable/non-removable volatile/nonvolatile computer storage media. By way of example only, FIG. 4 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 4, provide storage of computer readable instructions, data structures, program modules and other data for the computer 810. In FIG. 4, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies. They can also include search components 802 and 804.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 4 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 4 illustrates remote application programs 885 as residing on remote computer 880. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of operating a data storage system, implemented by a computer with a processor, comprising:
serving primary and secondary copies of at least six different availability groups using at least a first data store server, a second data store server and a third data store server;
detecting a failure of the first data store server; and
operating according to fail over operation by balancing a load for serving the primary copies of the availability groups served using the first data store server among the at least second data store server and third data store server.

2. The computer-implemented method of claim 1 and further comprising:
assigning the primary and secondary copies of the at least six different availability groups to the at least first, second and third data store servers according to an initial configuration.

3. The computer-implemented method of claim 2 wherein assigning the primary and secondary copies of the at least six different availability groups to the at least first, second and third data store servers according to an initial configuration, comprises:
load balancing the serving of the primary and secondary copies of the at least six different availability groups across the at least first, second and third data store servers.

4. The computer-implemented method of claim 3 wherein load balancing, comprises:
assigning service of primary copies of two different availability groups and secondary copies of two more different availability groups to each data store server in the initial configuration.

5. The computer-implemented method of claim 3 and further comprising:
detecting a remedy of the failure of the first data store server; and
restoring service of the primary and secondary copies of the at least six different availability groups to the at least first, second and third data store servers according to the initial configuration.

6. The computer-implemented method of claim 1 wherein each availability group includes a plurality of different databases that are migrated together for fail over operation.

7. The computer-implemented method of claim 6 wherein the data storage system includes at least first and second data centers and wherein detecting a failure comprises:
detecting the failure on the first data center.

8. The computer-implemented method of claim 7 and further comprising:
after detecting a failure on the first data center, determining whether the failure has a magnitude that meets a remote fail over threshold; and
if so, operating according to the fail over operation comprises operating according to a remote fail over operation by distributing the load of the primary and secondary copies of the availability groups among the data store servers on at least the second data center in the data storage system to load balance the data store servers on at least the second data center.

9. The computer-implemented method of claim 8 wherein determining whether the failure has a magnitude that meets a remote fail over threshold, comprises:
determining whether a number of failed data store servers on the first data center meets a threshold number.

10. The computer-implemented method of claim 9 wherein the data storage system includes at least the second data center and a third data center, and wherein distributing the load of the primary and secondary copies of the availability groups among the data store servers on at least a second data center in the data storage system, comprises:
distributing the load of the primary and secondary copies of the availability groups among the data store servers on at least the second and third data centers in the data storage system.

11. The computer-implemented method of claim 9 and further comprising:
assigning the primary and secondary copies of the at least six different availability groups, and first and second asynchronous copies of the at least six different availability groups to the data store servers on the at least first and second data centers according to an initial configuration.

12. The computer-implemented method of claim 11 wherein operating according to the remote fail over operation comprises:
assigning only the first and second asynchronous copies of the at least six different availability groups to the data store servers on the first data center.

13. The computer-implemented method of claim 12 and further comprising:
detecting a remedy of the failure of the first data center; and
restoring service of the primary and secondary copies of the at least six different availability groups to the data store servers on the at least first and second data centers according to the initial configuration

14. A data storage system, comprising:
a first data center, comprising:
at least a first data store server, a second data store server, and a third data store server, each serving primary and secondary copies of at least six different availability groups according to an initial, load balanced, configuration;
a second data center, comprising:
at least a fourth data store server, a fifth data store server, and a sixth data store server, each serving primary and secondary copies of at least six additional availability groups according to an initial, load balanced, configuration; and
at least one computer processor that detects failure of at least one of the data store servers in the data storage system and identifies it as a failed data store server and begins fail over operation by transferring service of at least the primary copies of the availability groups assigned to the failed data store servers, in a load balanced way, either to a remainder of the data store servers on a same data center as the failed data store server or to a set of data store servers on at least the second data center.

15. The data storage system of claim 14 wherein the at least one computer processor detects that the failure has been fixed, and transfers service of at least the primary copies of the availability groups back to the initial, load balanced, configuration.

16. The data storage system of claim 15 wherein the at least one processor detects a magnitude of the failover and assigns at least the primary copies of the availability groups assigned to the failed data store servers, in a load balanced way, either to a remainder of the data store servers on a same data center as the failed data store server or to a set of data store servers on at least the second data center based on the magnitude of the failure.

17. The data storage system of claim 16 wherein, when the at least one processor assigns at least the primary copies of the availability groups assigned to the failed data store servers, in a load balanced way, to the set of data store servers on at least the second data center, the at least one processor assigns only asynchronous copies of the availability groups to data store servers on the same data center as the failed data store server.

18. The data storage system of claim 17 wherein each availability group includes a plurality of different databases that are migrated together for fail over operation.

19. A computer-implemented method of operating a data storage system, implemented by a computer with a processor, comprising:
serving primary, secondary and first and second asynchronous copies of at least twelve different availability groups, according to a normal configuration, using at least a first data center with a first data store server, a second data store server and a third data store server, and a second data center with a fourth data store server, a fifth data store server and a sixth data store server, each availability group including a plurality of different databases that are migrated together for fail over operation;
detecting a failure, having a magnitude, of at least one of the data store servers;
performing a selected fail over operation comprising one of a remote fail over or a local fail over, based on the magnitude of the failure;
operating according to the selected fail over operation, comprising:
when the selected fail over operation comprises the local fail over operation, balancing a load for serving the primary and secondary copies of the availability groups served using the at least one failed data store server among a remainder of the data store servers in the data center of the at least one failed data store server; and
when the selected fail over operation comprises the remote fail over operation, balancing a load for serving the primary and secondary copies of the availability groups served using the at least one failed data store server among a the data store servers in the data center that does not include the at least one failed data store server;
detecting a remedy of the failure; and
performing a fail back operation comprising returning to the normal configuration.

20. The computer-implemented method of claim 19 wherein when the selected fail over operation comprises the remote fail over operation, assigning only asynchronous copies of the at least twelve different availability groups to the data center that includes the at least one failed data store server.
